(19) United States
(12) Patent Application Publication
(10) Pub. No.: US 2009/0268328 A1
(43) Pub. Date: Oct. 29, 2009

(54) METHOD OF EXAMINING STORAGE DISK AND STORAGE DISK EXAMINING APPARATUS

(75) Inventor: Takuya Kobayashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/346,361

(22) Filed: Dec. 30, 2008

(30) Foreign Application Priority Data
Apr. 25, 2008 (JP) 2008-114892

(51) Int. Cl. G11B 27/36; G11B 21/02

(52) U.S. Cl. 360/31; 360/75; G9B/27.052; G9B/21.003

(57) ABSTRACT

A method of examining a storage disk is proposed. The method repeats steps of: executing a writing operation and a reading operation in sequence to recording tracks at first intervals so as to check a defect in the recording tracks based on the quality of a read signal; and selecting a recording track at a position spaced by a second interval larger than the first interval from a last recording track of the sequence, the recording track being a first recording track of the recording tracks at the first intervals. The method realizes detection of a defect for recording tracks at the first intervals in a concentrated manner. A recording track is then selected at a position spaced by the second interval from the sequence. A defect can reliably be detected without increasing the total number of recording tracks selected as sample tracks.

### CROSS-REFERENCE TO RELATED APPLICATION

This application is based upon and claims the benefit of priority from the prior Japanese Patent Application No. 2008-114892 filed on Apr. 25, 2008, the entire contents of which are incorporated herein by reference.

### BACKGROUND OF THE INVENTION

1. Field of the Invention

The present invention relates to a method of examining a storage disk having recording tracks at predetermined intervals. In particular, the present invention relates to a method of examining a storage or recording disk incorporated in a hard disk drive, HDD, for example.

2. Description of the Prior Art

A method of examining a storage or magnetic recording disk is well known. The method is designed to select a recording track every predetermined pitch (distance) on the magnetic recording disk. Writing and reading operation of data is executed to the selected recording tracks. A defect is determined based on the quality of a read signal read out of the selected recording track.

An increased recording density requires an increase in the number of recording tracks. If a recording track is selected every predetermined pitch (distance) in the conventional manner, the ratio of sample tracks to the total amount of recording tracks decreases. The examination suffers from an increased probability of failure to detect a defect. On the other hand, if the ratio of sample tracks to the total amount of recording tracks is to be maintained, the pitch must be reduced. The number of sample tracks increases. The throughput thus deteriorates.

### SUMMARY OF THE INVENTION

It is accordingly an object of the present invention to provide a method of examining a storage disk enabling a reliable detection of a defect without deterioration of the throughput.

According to a first aspect of the present invention, there is provided a method of examining a storage disk, comprising repeating steps of: executing a writing operation and a reading operation in sequence to recording tracks at first intervals so as to check a defect in the recording tracks based on the quality of a read signal; and selecting a recording track at a position spaced by a second interval larger than the first interval from a last recording track of the sequence, the recording track being a first recording track of the recording tracks at the first intervals.

The method realizes detection of a defect for recording tracks at the first intervals in a concentrated manner. A recording track is then selected at a position spaced by the second interval from the sequence. In this manner, a defect can reliably be detected without increasing the total number of recording tracks selected as sample tracks.

According to a second aspect of the present invention, there is provided a method of examining a storage disk, comprising: executing a writing operation and a reading operation in sequence to recording tracks at first intervals so as to check a defect in the recording tracks based on the quality of a read signal; and executing a writing operation and a reading operation in sequence to recording tracks at second intervals so as to check a defect in the recording tracks when a defect has been detected in the recording tracks at the first intervals, the second interval being set smaller than the first interval.

The method allows examination on the recording tracks at relatively short intervals after a defect has been detected. A defect can thus reliably be detected without increasing the total number of recording tracks selected as sample tracks.

A specific storage disk examining apparatus may be provided to realize the method according to the first aspect. The specific storage disk examining apparatus comprises: a spindle motor; a carriage related to the spindle motor; a head supported on the carriage for writing and reading operation of data; and a controller circuit controlling the operation of the carriage so as to control the positioning of the head. The controller circuit may repeat the operation to make the head discretely move at first intervals and the operation to make the head move by a second interval, the second interval being set larger than the first intervals.

A specific storage disk examining apparatus may be provided to realize the method according to the first aspect. The specific storage disk examining comprises: storage disk examining apparatus comprising: a spindle motor; a carriage related to the spindle motor; a head supported on the carriage for writing and reading operation of data; and a controller circuit controlling the operation of the carriage so as to control the positioning of the head. The controller circuit makes the head discretely move at first intervals. The controller circuit makes the head discretely move at second intervals when a defect has been detected, the second intervals being set smaller than the first intervals.

Additional objects and advantages of the invention will be set forth in part in the description which follows and, in part will be obvious from the description, or may be learned by practice of the present invention. The object and advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a view schematically illustrating the structure of a storage disk examining apparatus according to an example of the present invention;

FIG. 2 is a schematic view schematically illustrating the arrangement of recording tracks selected as sample tracks in accordance with a method of examining a recording track according to a first embodiment of the present invention;

FIG. 3 is a view showing a defect distribution map established when a sample track is taken every 2 μm pitch;

FIG. 4 is a view showing a defect distribution map established when a sample track is taken every 12 μm pitch;

FIG. 5 is a view showing a defect distribution map established when a group of a recording track sequence including sample tracks is taken every 20 μm pitch; and

FIG. 6 is a view showing a defect distribution map established when a group of a recording track sequence including sample tracks is taken every 30 μm; and

FIG. 7 is a schematic view schematically illustrating the arrangement of recording tracks selected as sample tracks in accordance with a method of examining a recording track according to a second embodiment of the present invention.

### DESCRIPTION OF THE PREFERRED EMBODIMENTS

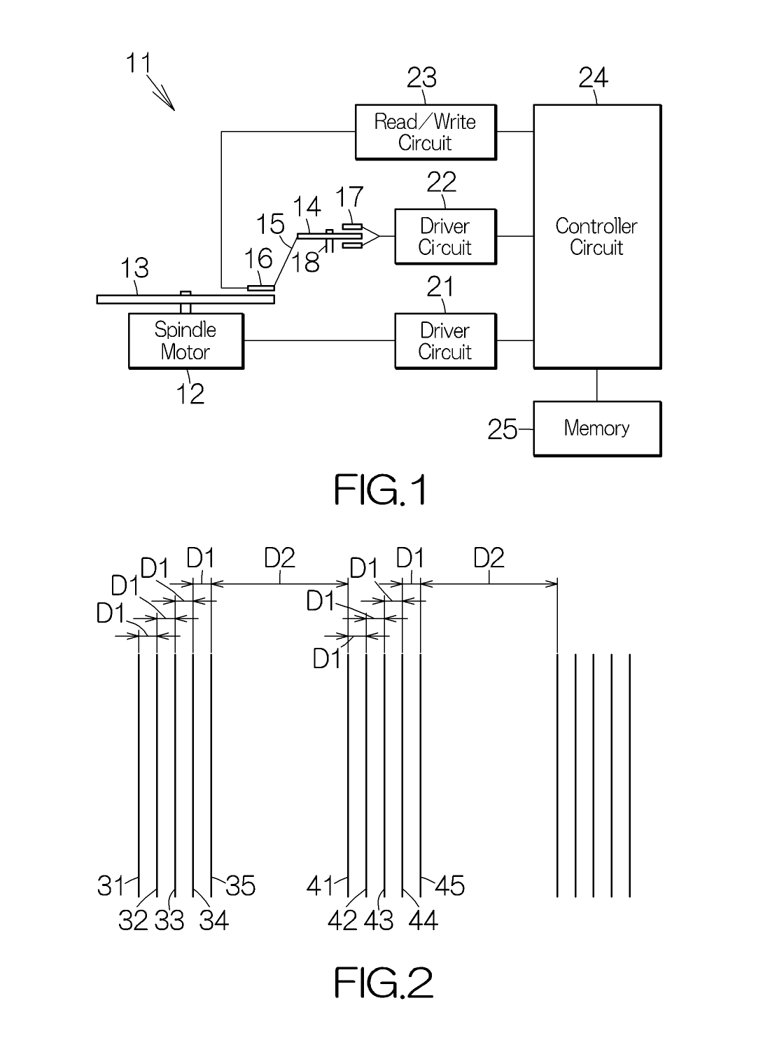

FIG. 1 schematically illustrates the structure of a storage disk examining apparatus 11 according to an example of the present invention. The storage disk examining apparatus 11 includes a spindle motor 12. A storage disk as a test sample, namely a magnetic recording disk 13, is mounted on the spindle motor 12, for example. The spindle motor 12 drives the magnetic recording disk 13 at a predetermined rotation speed.

A so-called carriage 14 is related to the spindle motor 12. A head suspension 15 is attached to the carriage 14. A flexure is bonded to the head suspension 15. A gimbal is defined in the flexure at the front or tip end of the head suspension 15. A flying head slider 16 is mounted on the gimbal. The gimbal allows the flying head slider 16 to change its attitude relative to the head suspension 15. A magnetic head, namely an electromagnetic transducer, is mounted on the flying head slider 16.

When the magnetic recording disk 13 rotates, the flying head slider 16 is allowed to receive airflow generated along the rotating magnetic recording disk 13. The airflow serves to generate a positive pressure or a lift as well as a negative pressure on the flying head slider 16. The flying head slider 16 is thus allowed to keep flying above the surface of the magnetic recording disk 13 during the rotation of the magnetic recording disk 13 at a higher stability established by the balance between the urging force of the head suspension 15 and the combination of the lift and the negative pressure.

A power source, namely a voice coil motor, VCM, 17 is coupled to the carriage 14. The voice coil motor 17 serves to drive the carriage 14 around a vertical support shaft 18. The rotation of the carriage 14 allows the head suspensions 15 to swing. When the carriage 14 swings around the vertical support shaft 18 during the flight of the flying head slider 16, the flying head slider 16 is allowed to move along the radial direction of the magnetic recording disk 13. The electromagnetic transducer on the flying head slider 16 is in this manner positioned right above a target recording track on the magnetic recording disk 13.

A driver circuit 21 is connected to the spindle motor 12. The driver circuit 21 is designed to control the rotation of the spindle motor 12. A driver circuit 22 is connected to the voice coil motor 17. The driver circuit 22 is designed to control the operation of the voice coil motor 17. The operation of the voice coil motor 17 is controlled so as to position the electromagnetic transducer. A read/write circuit 23 is connected to the electromagnetic transducer on the flying head slider 16. The read/write circuit 23 is designed to supply a sensing current to the read element of the electromagnetic transducer. Variation in the voltage appearing in the sensing current is utilized to discriminate binary data on a recording track. The read/write circuit 23 is also designed to supply a writing current to the write element of the electromagnetic transducer. A predetermine magnetic field is generated in the write element in response to the supply of the writing current. The magnetic field acts on the magnetic recording disk 13. Binary data is in this manner written on a recording track on the magnetic recording disk 13.

A controller circuit 24 is connected to the driver circuit 21, the driver circuit 22 and the read/write circuit 23. The controller circuit 24 executes an examination in accordance with a predetermined software program. A storage medium 25 such as a memory is connected to the controller circuit 24. The predetermined software program is stored in the storage medium 25.

Next, a detailed description will be made on the operation of the controller circuit 24 in accordance with a method of examining according to a first embodiment. When a test sample, namely the magnetic recording disk 13, is mounted on the spindle motor 12, the controller circuit 24 instructs the driver circuit 21 to drive the spindle motor 12. A predetermined instruction signal is supplied to the driver circuit 21. The driver circuit 21 drives the spindle motor 12 to rotate in response to reception of the instruction signal. The magnetic recording disk 13 is driven to rotate at a predetermined rotation speed.

The controller circuit 24 instructs the driver circuit 22 to position the electromagnetic transducer. A predetermined instruction signal is supplied to the driver circuit 22. The electromagnetic transducer is positioned right above a recording track as the first sample track. The recording track as the first sample track may be either the outermost or innermost one of the recording tracks.

The controller circuit 24 instructs the read/write circuit 23 to write test data. Sample binary data is supplied from the controller circuit 24 to the read/write circuit 23. The electromagnetic transducer serves to write the test data into the first sample track based on the supplied sample binary data.

The controller circuit 24 instructs the read/write circuit 23 to read data. The read/write circuit 23 discriminates binary data by using variation in the voltage appearing in the sensing current. The result of discrimination is output to the controller circuit 24.

The controller circuit 24 compares the discriminated binary data with the sample binary data supplied to the read/write circuit 23. If the discriminated binary data coincides with the sample binary data, the controller circuit 24 determines that the reading/writing operation of data is normal. If the discriminated binary data is different from the sample binary data, the controller circuit 24 determines detection of a defect. If the defect is observed over continuous data bits of the predetermined number or larger, the controller circuit 24 determines detection of a critical defect. The defect or critical defect is registered in the memory 25 along with the identifier of the recording track, for example. Simultaneously, the angular position of the defect is specified in the record. The encoder of the spindle motor 12, the number of the servo sector on the magnetic recording disk 13, or the like may be utilized to specify the angular position.

When the writing/reading operation has been completed for the recording track as the first sample track, the controller circuit 24 instructs the driver circuit 22 to move the electromagnetic transducer. A predetermined instruction signal is supplied to the driver circuit 22. As shown in FIG. 2, the electromagnetic transducer is moved from the first sample recording track 31 in the radial direction of the magnetic recording disk 13 by a first interval D1. Here, the first interval D1 is set at 1 μm, for example. The electromagnetic transducer is positioned right above the second sample recording track 32. Writing/reading operation of the sample binary data is executed in the same manner as described above. The controller circuit 24 checks a defect in the second sample recording track 32 based on the quality of the read signal in the same manner as described above. In this manner, writing/reading operation is effected on the sample recording tracks 31, 32, 33, 34, 35 in sequence at the first intervals D1. A defect is checked for each of the sample recording tracks 31-35 based on the quality of the read signal.

A first sample recording track 41 is then selected at a position spaced from the last sample track of the aforementioned sequence, namely the sample recording track 35, by a second interval D2 larger than the first interval D1. Here, the second interval D2 is set at 56 μm, for example. The electromagnetic transducer is moved from the sample recording track 35 in the radial direction of the magnetic recording disk 13 by the second interval D2. The electromagnetic transducer is thus positioned right above the first sample track of the following sequence, namely the first sample recording track 41. Writing/reading operation of the sample binary data is effected in the same manner as described above. The controller circuit 24 checks a defect in the first sample recording track 41 based on the quality of the read signal in the same manner as described above. Writing/reading operation is subsequently executed for recording tracks 42, 43, 44, 45 in sequence at the first intervals D1. A defect is checked for each of the recording tracks 42, 43, 44, 45 based on the quality of the read signal. In this manner, the sample tracks are selected from groups of a recording track sequence spaced from one another at the second intervals D2. The sample tracks are spaced from one another at the intervals D1 in the individual recording track sequence.

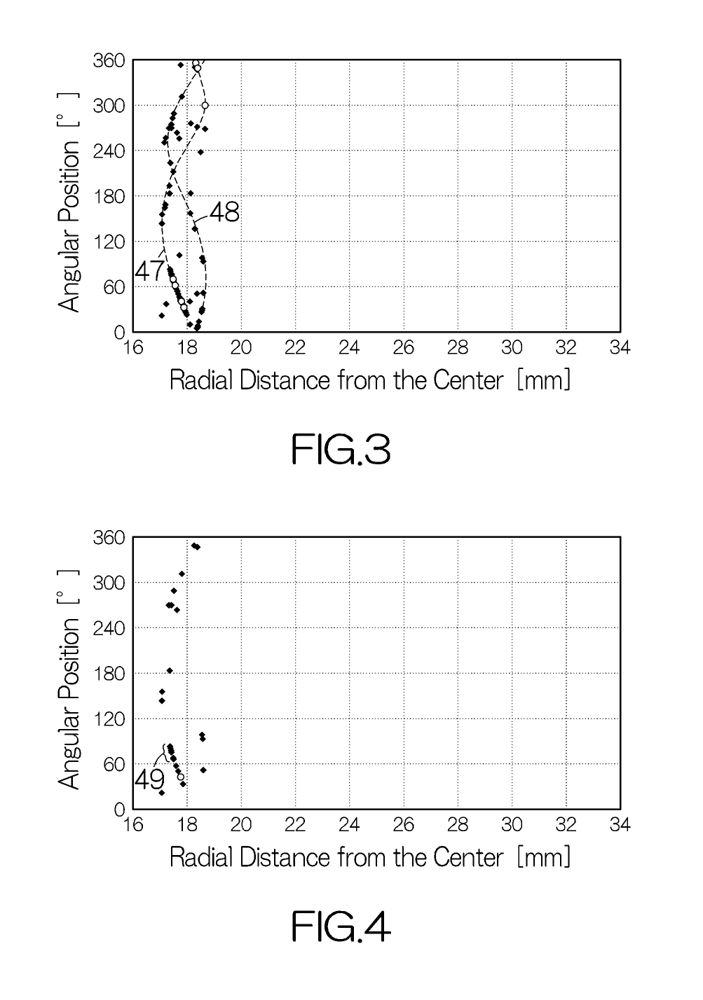

FIG. 3 shows an example of a defect distribution map. Sample tracks were selected every 2 μm pitch from recording tracks of 200 nm pitch. When a defect was observed over 10 continuous data bits or more, for example, it was determined as a critical defect. In FIG. 3, a hollow dot mark denotes a critical defect. When a defect was observed over nine continuous data bits or less, it was determined as a minor defect. In FIG. 3, a black diamond mark denotes a minor defect. Two textural scratches 47, 48 can be observed in the defect distribution map of FIG. 3, for example. If a textural scratch is observed on the magnetic recording disk 13, the magnetic recording disk 13 is excluded as an inappropriate product. In general, the surface of the substrate is subjected to texturing process in the process of making the magnetic recording disk 13. A piece of cloth is urged against the surface of the rotating substrate in the texturing process. Abrasive grains are supplied between the cloth and the substrate. The piece of cloth reciprocates in the radial direction of the substrate. A textural scratch is caused due to the abrasive grains of relatively large size. The textural scratch appears as a wavy line extending in the circumferential direction of the substrate.

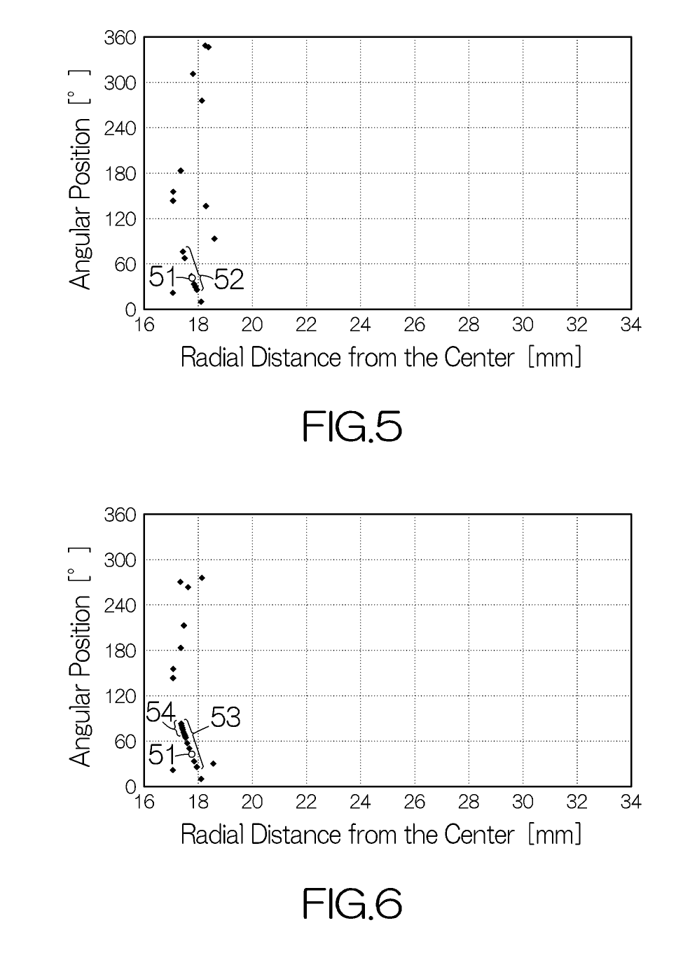

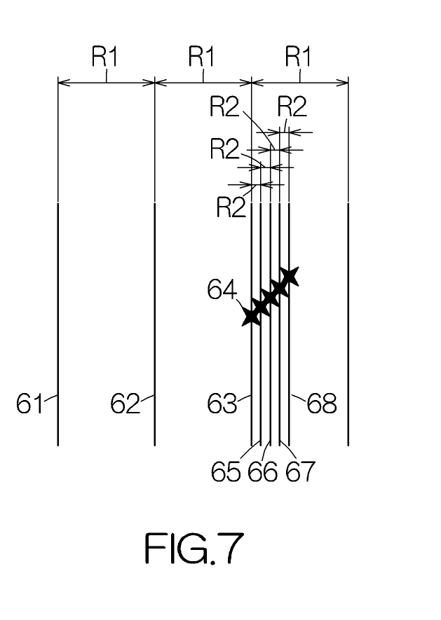

FIG. 4 shows another example of a defect distribution map. The magnetic recording disk 13 having a defect of FIG. 3 was examined so as to make this defect distribution map. A sample track was selected every 12 μm. The textural scratch was obviously fragmented. One critical defect was observed. Four successive minor defects 49 were observed.

FIG. 5 shows another example of a defect distribution map. The magnetic recording disk 13 having a defect of FIG. 3 was likewise examined so as to make this defect distribution map. A recording track sequence was taken every second interval D2 of 20 μm. The individual recording track sequence comprised two recording tracks spaced from each other at the first interval D1 of 2 μm. In other words, the total number of the recording tracks selected as sample tracks was set equal to that of the recording tracks of 12 μm pitch. One critical defect 51 and four minor defects 52 near the critical defect 51 were observed. It has been confirmed that a criterion is clarified for detection of a defect without changing the total number of the sample tracks.

FIG. 6 shows another example of a defect distribution map. The magnetic recording disk 13 having a defect of FIG. 3 was likewise examined so as to make this defect distribution map. A recording track sequence was taken every second interval D2 of 30 μm. The individual recording track sequence included three recording tracks spaced from one another at first intervals D1 of 2 μm. In other words, the total number of the recording tracks selected as sample tracks was set equal to that of the recording tracks of 12 μm pitch. One critical defect 51 and eleven (11) minor defects 53 near the critical defect 51 were observed. In addition, six of the minor defects 53, namely minor defects 54, were observed closest to one another in any other cases. It has been confirmed that a textural scratch can be detected with high accuracy in accordance with such a criterion. It has been observed that a criterion is further clarified for detection of a defect without changing the total number of sample tracks.

Next, a detailed description will be made on the operation of the controller circuit 24 in accordance with a method of examining according to a second embodiment. Writing/reading operation of data is effected on the recording tracks 61, 62, 63 in sequence at first intervals R1. Here, the first interval R1 is set at 12 μm, for example. A predetermined instruction signal is supplied from the controller circuit 24 to the driver circuit 22 so as to position the electromagnetic transducer in the same manner as described above. A defect is checked for each of the recording tracks 61-63 based on the quality of the read signal in the same manner as described above.

If a defect 64 is detected in the recording track 63, writing/reading operation is effected on recording tracks 65, 66, 67, 68 in sequence at second intervals R2 smaller than the first intervals R1. Here, the second interval R2 is set at 1 μm, for example. A defect is checked for each of the recording tracks 65-68 based on the quality of the read signal. If defects are continuously detected in the recording tracks 63-68, the controller circuit 24 determines the existence of a textural scratch.

It should be noted that the aforementioned first interval D1, second interval D2, first interval R1 and second interval R2 can appropriately be determined depending on the amplitude and/or the size of a textural scratch.

The turn of the embodiments is not a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A method of examining a storage disk, comprising repeating steps of:
executing a writing operation and a reading operation in sequence to recording tracks at first intervals so as to check a defect in the recording tracks based on quality of a read signal; and
selecting a recording track at a position spaced by a second interval larger than the first interval from a last recording track of the sequence, the recording track being a first recording track of the recording tracks at the first intervals.

2. A method of examining a storage disk, comprising:
executing a writing operation and a reading operation in sequence to recording tracks at first intervals so as to check a defect in the recording tracks based on quality of a read signal; and
executing a writing operation and a reading operation in sequence to recording tracks at second intervals so as to check a defect in the recording tracks when a defect has been detected in the recording tracks at the first intervals, the second interval being set smaller than the first interval.

3. A storage disk examining apparatus comprising:
a spindle motor;
a carriage related to the spindle motor;
a head supported on the carriage for writing and reading operation of data; and
a controller circuit controlling an operation of the carriage so as to control positioning of the head, the controller circuit repeating an operation to make the head discretely move at first intervals and an operation to make the head move by a second interval, the second interval being set larger than the first intervals.

4. A storage disk examining apparatus comprising:
a spindle motor;
a carriage related to the spindle motor;
a head supported on the carriage for writing and reading operation of data; and
a controller circuit controlling an operation of the carriage so as to control positioning of the head, the controller circuit making the head discretely move at first intervals, the controller circuit making the head discretely move at second intervals when a defect has been detected, the second intervals being set smaller than the first intervals.
